(19) United States
(12) Patent Application Publication
(10) Pub. No.: US 2026/0279684 A1
(43) Pub. Date: Sep. 17, 2026

(54) ELECTRONIC DEVICE AND METHOD FOR MANUFACTURING THEREOF

(71) Applicant: TDK Corporation, Tokyo (JP)

(72) Inventors: Toshio SAKURAI, Tokyo (JP); Masahide ISHIZUYA, Tokyo (JP); Makoto ISHIZAKI, Tokyo (JP); Asuka MURAKAMI, Tokyo (JP)

(73) Assignee: TDK Corporation, Tokyo (JP)

(21) Appl. No.: 19/564,576

(22) Filed: Mar. 12, 2026

(30) Foreign Application Priority Data
Mar. 13, 2025 (JP) 2025-040632

(51) Int. Cl. H01G 4/30; H01G 4/232

(52) U.S. Cl. CPC H01G 4/30; H01G 4/232

(57) ABSTRACT

An electronic device, having: an element main body including; a multilayer body having an internal electrode layer and a dielectric layer, both being substantially parallel to a plane including a first axis and a second axis perpendicular to the first axis, and stacked along a direction of a third axis perpendicular to the plane including the first axis and the second axis, and a gap part formed toa side surface disposed at an end in a direction of the first axis of the multilayer body; and an external electrode electrically connected to the internal electrode layer; wherein a boundary part between the multilayer body and the gap part exposed on an end surface being disposed at an end in a direction of the second axis of the element main body is at least partially covered by an end surface covering part, an area ratio of the end surface covering part is between 20% or greater and 50% or less with respect to 100% of an area of the end surface, and the external electrode covers at least part of the end surface and at least part of the end surface covering part.

### TECHNICAL FIELD

The present disclosure relates to an electronic device and a method for manufacturing the electronic device.

### BACKGROUND

In recent years, for digital electronic devices such as mobile phones, numerous and various electronic devices are installed to electronic circuits for information processing and signal processing, or to power circuits. As one example of such electronic devices, a multilayer ceramic capacitor is known which includes an element main body in which a dielectric layer and an internal electrode layer are stacked, and an external electrode electrically connected to the internal electrode layer.

Downsizing and achieving higher performance of such digital electronic devices are progressing rapidly. Thus, demands for downsizing and achieving larger capacity of the multilayer ceramic capacitor mounted on the digital electronic devices are high.

In response to such demands, in order to increase an area of the internal electrode layer while downsizing the multilayer ceramic capacitor, Patent Document 1 forms a side margin made of dielectrics to a side surface of the ceramic multilayer body where the side part of the internal electrode layer is exposed.

During the firing of a multilayer chip having a side margin, the internal electrode positioned at a boundary between the side margin and the multilayer chip recede inwards and voids tend to be formed at the boundary. A fluid such as a plating solution used for a wet process of a plating step etc., when forming the external electrode after the firing, tends to easily infiltrate into the voids formed at the boundary. When such fluid infiltrates into the void, an insulation property, lifetime characteristic, etc., of the multilayer ceramic capacitor decline, and thus, the reliability of the capacitor also declines.

### PRIOR ART DOCUMENT

### Patent Document

[Patent Document 1] JP Patent Application Laid Open No. S62-237714

### SUMMARY

The present disclosure is achieved in view of such circumstances, and the object is to provide an electronic device having an excellent reliability.

In order to achieve the above-mentioned object, the gist of the electronic device according to the present disclosure is as described in below.

[1] An electronic device, having:
an element main body including;
   a multilayer body having an internal electrode layer and a dielectric layer, both being substantially parallel to a plane including a first axis and a second axis perpendicular to the first axis, and stacked along a direction of a third axis perpendicular to the plane including the first axis and the second axis, and
   a gap part formed to a side surface disposed at an end in a direction of the first axis of the multilayer body; and
an external electrode electrically connected to the internal electrode layer;
   wherein a boundary between the multilayer body and the gap part exposed on an end surface being disposed at an end in a direction of the second axis of the element main body is at least partially covered by an end surface covering part,
   an area ratio of the end surface covering part is between 20% or greater and 50% or less with respect to 100% of an area of the end surface, and
the external electrode covers at least part of the end surface and at least part of the end surface covering part.

[2] An electronic device, having:
an element main body including;
   a multilayer body having an internal electrode layer and a dielectric layer, both being substantially parallel to a plane including a first axis and a second axis perpendicular to the first axis, and stacked along a direction of a third axis perpendicular to the plane including the first axis and the second axis, and
   a gap part formed to a side surface disposed at an end in a direction of the first axis of the multilayer body; and
an external electrode electrically connected to the internal electrode layer;
   wherein a boundary part between the multilayer body and the gap part exposed on an end surface being disposed at an end in a direction of the second axis of the element main body is at least partially covered by an end surface covering part,
   the end surface covering part at least partially covers the gap part and has a covering length of 10 μm or greater and 55 μm or less from the boundary towards a center in the direction of the first axis of the end surface, and
the external electrode covers at least part of the end surface covering part and at least part of the end surface.

[3] The electronic device according to [1] or [2], wherein the end surface has a plurality of end surface covering parts formed on the end surface.

[4] The electronic device according to any one of [1] to [3], wherein a length of the end surface covering part in a direction along the second axis is between 4 μm or greater and 15 μm or less.

[5] The electronic device according to any one of [1] to [4], wherein the end surface covering part includes a dielectric.

[6] The electronic device according to any one of [1] to [5], wherein the external electrode includes an underlayer and a plating layer formed on the underlayer.

[7] A method for manufacturing the electronic device according to any one of [1] to [6], including:
forming of a green multilayer body by stacking an internal electrode pattern layer and a green sheet, both substantially parallel to a plane including a first axis and a second axis, along a direction of a third axis,
   the internal electrode pattern layer being exposed from a side surface disposed at an end in a direction of a first axis of the green multilayer body and also being exposed from an end surface disposed at an end in a direction of a second axis of the green multilayer body;
obtaining a green chip by forming a green gap part to the side surface;
forming a green covering part covering a boundary between the green multilayer body and the green gap part to the end surface disposed at the end in the direction of the second axis of the green chip;
obtaining an element main body having the end surface covering part by firing the green chip provided with the green covering part; and
forming an external electrode on the end surface disposed at the end in the direction of the second axis of the element main body to cover at least part of the end surface covering part and at least part of the end surface.

[8] The method for manufacturing the electronic device according to [7], wherein forming of the green covering part includes applying an end surface sheet to the end surface of the green chip.

[9] The method for manufacturing the electronic device according to [7], wherein forming the green covering part includes immersing the end surface of the green chip in an end surface paste.

### BRIEF DESCRIPTION OF DRAWINGS

FIG. 1 is a schematic perspective view of a multilayer ceramic capacitor according to an embodiment of the present disclosure.

FIG. 2 is a schematic perspective view of an element main body included in the multilayer ceramic capacitor according to an embodiment of the present disclosure.

FIG. 3 is a cross-sectional view along a line III-III shown in FIG. 2.

FIG. 4 is a cross-sectional view along a line IV-IV shown in FIG. 2.

FIG. 5 is a plan view of an end surface of the element main body shown in FIG. 2.

FIG. 6 is a plan view of an upper surface of the element main body shown in FIG. 2.

FIG. 7A is a schematic cross-sectional view parallel to an X-axis and a Z-axis showing a stacking step of a green sheet during manufacturing steps of the multilayer ceramic capacitor shown in FIG. 1.

FIG. 7B is a schematic cross-sectional view parallel to a Y-axis and a Z-axis showing the stacking step of the green sheet shown in FIG. 7A.

FIG. 8A is a schematic perspective view of a green multilayer body after a cutting step following the stacking step shown in FIG. 7A and FIG. 7B.

FIG. 8B is a schematic perspective view of a green chip after forming a green gap part to a side surface of the green multilayer body shown in FIG. 8A.

FIG. 8C is a schematic perspective view of the green chip after forming a green covering part to the end surface of the green chip shown in FIG. 8B.

### DETAILED DESCRIPTION

Hereinafter, the present disclosure is explained in detail based on specific embodiments shown in the figures.

### 1. First Embodiment

As one embodiment of the electronic device according to the present embodiment, as an example, a multilayer ceramic capacitor is described. First, overall configuration of the multilayer ceramic capacitor is described.

### (1.1. Overall Configuration of Multilayer Ceramic Capacitor)

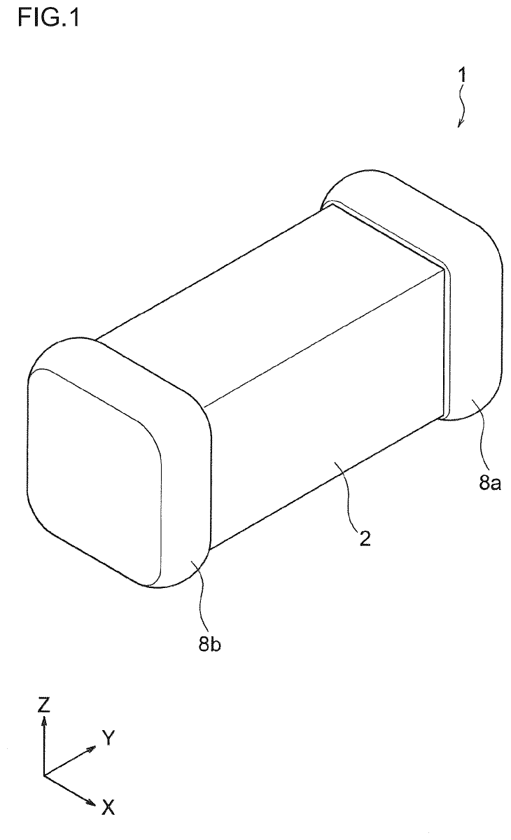

FIG. 1 is a perspective view of the multilayer ceramic capacitor. The X-axis, the Y-axis, and the Z-axis in FIG. 1 are perpendicular to each other. The same applies to the rest of the figures. The multilayer ceramic capacitor 1 includes an element main body 2 and external electrodes 8a and 8b, which are formed on both end surfaces facing each other in a direction of the Y-axis among the surfaces of the element main body 2. The element main body 2 includes a dielectric layer (not shown in the figure) including a dielectric which exhibits a dielectric property, and an internal electrode layer (not shown in the figure) which includes a conductor.

The dielectric layer includes a dielectric having a perovskite structure, a tungsten bronze structure, and the like as a main component. Examples of the dielectric having the perovskite structure include a compound represented by a chemical formula ABO₃. In ABO₃, “A” is an element occupying the A-site of the perovskite structure, and examples of such element include at least one selected from the group consisting of barium (Ba), calcium (Ca), and strontium (Sr). In ABO₃, “B” is an element occupying the B-site of the perovskite structure, and examples of such element include at least one selected from the group consisting of titanium (Ti), and zirconium (Zr). The molar ratio of A to B (A/B) is, for example, between 0.980 and 1.020.

The dielectric layer may further include a subcomponent in addition to the above main component. A type and an amount of the subcomponent may be determined based on desired properties. Examples of such subcomponent include one or more oxides of at least one element selected from the group consisting of manganese (Mn), chromium (Cr), cobalt (Co), nickel (Ni), and iron (Fe); one or more oxides of at least one element selected from the group consisting of vanadium (V), molybdenum (Mo), and tungsten (W); one or more oxides of at least one rare earth element; oxide of magnesium (Mg); and one or more oxides of at least one element selected from the group consisting of silicon (Si), lithium (Li), aluminum (Al), germanium (Ge), barium (Ba), calcium (Ca), and boron (B).

A thickness of the dielectric layer is determined appropriately based on usage or so, and it is normally about 0.5 to 20 μm per layer. The number of dielectric layers is normally about 2 to 1000 layers.

The conductor included in the internal electrode layer is not particularly limited, and metals such as Ni, copper (Cu), silver (Ag), palladium (Pd), aluminum (Al), platinum (Pt), and alloy thereof can be used. As a Ni alloy, preferably the alloy may be made of Ni and one or more elements selected from the group consisting of Mn, Cr, Co, and Al; and, preferably a Ni amount in the alloy is 95 wt % or greater. Note that, in Ni or the Ni alloy, various trace components such as phosphorous (P) may be included in an amount of 0.1 wt % or less. The internal electrode layer may be formed using a commercially available electrode paste, and a thickness of the internal electrode layer may be determined appropriately according to usage and so on.

In the present embodiment, the external electrodes 8a and 8b include a underlayer (not shown in the figure) formed to at least partially cover the end surfaces of the element main body 2, and a plating layer (not shown in the figure) formed on the underlayer. The underlayer may be configured of Cu, Ni, etc. Examples of the plating layer include a Ni plating, a Cu plating, and a Sn plating. In the present embodiment, a terminal structure has the Ni plating layer formed on a Cu fired layer, and the Sn plating layer formed on the Ni plating layer. A thickness of each of the external electrodes 8a and 8b is determined appropriately based on usage or so.

### (1.2. Element Main Body)

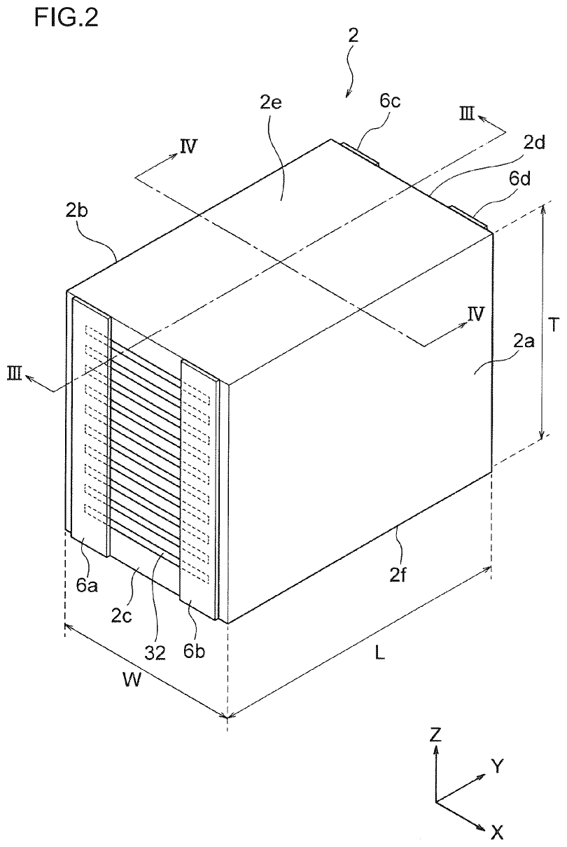

FIG. 2 is a schematic perspective view of the element main body 2 included in the multilayer ceramic capacitor 1 shown in FIG. 1. That is, the external electrodes are not shown in the multilayer ceramic capacitor 1 of FIG. 2 In FIG. 2, surfaces disposed at ends in the X-axis direction are deemed side surfaces 2a and 2b of the element main body 2; surfaces disposed at ends in the Y-axis direction are deemed end surfaces 2c and 2d of the element main body 2; and surfaces disposed at ends in the Z-axis direction are deemed an upper surface 2e and a lower surface 2f of the element main body 2.

A size of the element main body preferably may be a length W in the X-axis direction of 0.1 mm or longer and 3.2 mm or shorter, a length L in the Y-axis direction of 0.2 mm or longer and 4.5 mm or shorter, and a length T in the Z-axis direction of 0.1 mm or longer and 3.2 mm or shorter.

In FIG. 2, the internal electrode layer 32 is exposed at the end surface 2c of the element main body 2. The exposed internal electrode layer 32 is electrically connected to the external electrodes 8a and 8b shown in FIG. 1. In the present embodiment, the both end parts in the X-axis direction of the internal electrode layer 32 are covered with two end surface covering parts 6a and 6b. Likewise, the both ends in the X-axis direction of the internal electrode layer 32 exposed at the end surface 2d of the element main body 2 (not shown in the figure) are also covered with two end surface covering parts 6c and 6d. Also, in the multilayer ceramic capacitor 1, together with the end surfaces 2c and 2d, the end surface covering parts 6a to 6d are covered with the external electrodes 8a and 8b shown in FIG. 1. The end surface covering part is explained later.

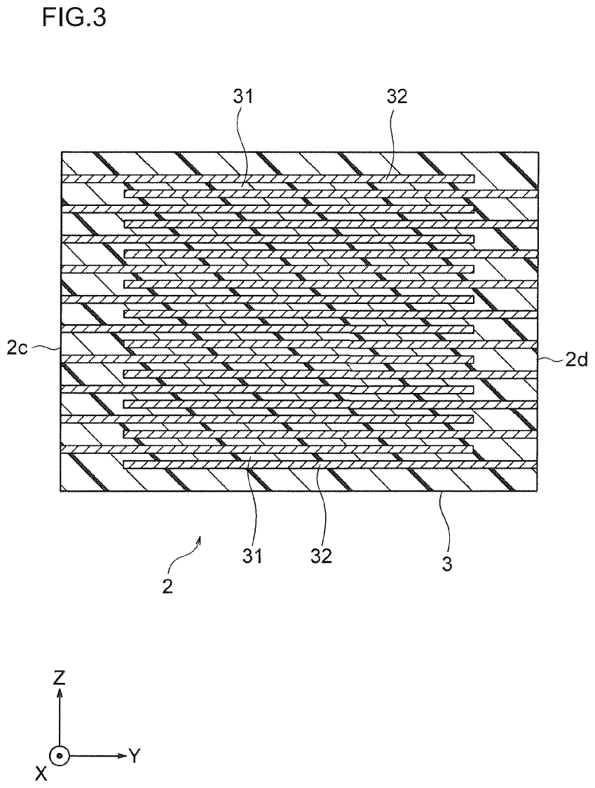

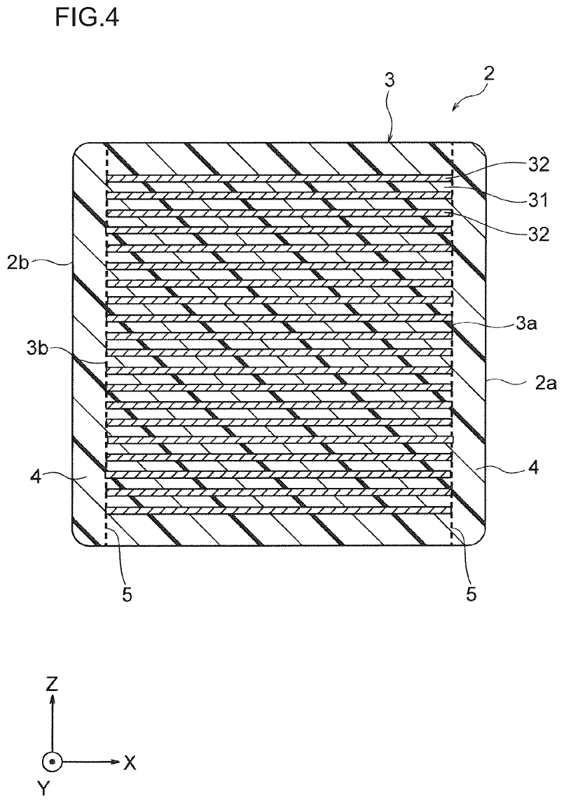

FIG. 3 shows a cross-section of the element main body 2 along the line III-III shown in FIG. 2, and FIG. 4 shows a cross-section of the element main body 2 along the line IV-IV shown in FIG. 2.

As shown in FIGS. 3 and 4, the element main body 2 includes a multilayer body 3 and a gap part 4. The multilayer body 3 includes dielectric layers 31 and internal electrode layers 32 which are substantially parallel to the plane including the X-axis and the Y-axis, and the dielectric layers 31 and the internal electrode layers 32 are stacked alternatingly in the Z-axis direction so that the internal electrode layer is placed between the dielectric layers. The gap part 4 is formed to each of the side surfaces 3a and 3b facing each other in the X-axis direction of the multilayer body. In the present embodiment, the multilayer body 3 and the gap part 4 are integrally formed. Note that, “substantially parallel” means that most parts are parallel, and there may be some parts which are not necessarily parallel. This means that the internal electrode layer 32 and the dielectric layer 31 may be more or less uneven or slanted.

At each of the side surfaces 3a and 3b of the multilayer body 3, the end part of the internal electrode layer 32 in the X-axis direction is positioned, and the gap part 4 covers this end part. By forming the gap part, it is possible to prevent the fluid such as moisture, etc., from infiltrating into the internal electrode layer; and thereby, enables to increase an effective area of the internal electrode layer with respect to the size of the electronic device. Thereby, it is possible to obtain the electronic device which is even more downsized and also achieving higher performance.

### (1.3. End Surface Covering Part)

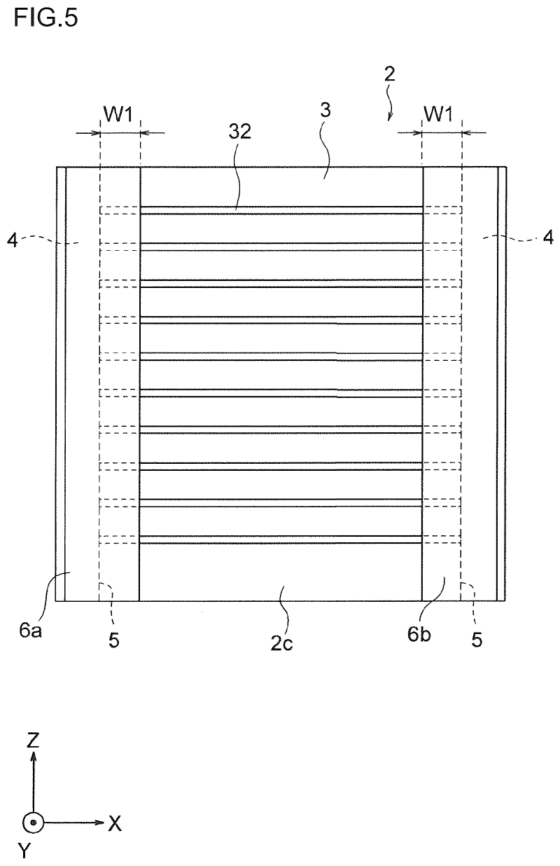

FIG. 5 is a plan view of the end surface 2c of the element main body 2 shown in FIG. 2. As mentioned in above, at the end surface 2c, the end surface covering parts 6a and 6b are covering the end parts in the X-axis direction of the internal electrode layer 32. As apparent from FIG. 4, this end part configures a boundary 5 between the multilayer body 3 and the gap part 4. That is, the end surface covering parts 6a and 6b cover the boundary 5 between the internal electrode layer 32 and the gap part 4.

As long as the end surface covering part covers the boundary, one end surface covering part may be formed on one end surface, or more than one end surface covering parts may be formed on one end surface. In the present embodiment, preferably more than one end surface covering parts may be formed on one end surface. Thereby, it is easier to ensure sufficient electrical connection between the internal electrode layer and the external electrode. In FIG. 5, two end surface covering parts 6a and 6b are disposed taking a predetermined space between each other to cover the boundary 5.

Normally, the gap part is formed in a state of a green body (green gap part) to the side surface a green body of the multilayer body (green multilayer body), and configures a green chip together with the green multilayer body. Then, the green multilayer body and the green gap part are integrated during the firing of the green chip to form the element main body.

In the present embodiment, regarding the green multilayer body, the internal electrode pattern layer which becomes the internal electrode layer after firing is formed so that the end part of the internal electrode pattern layer pattern is exposed to the side surface and the end surface of the green multilayer body. Thus, at the boundary between the green multilayer body and the green gap part, the green gap part and the end part of the internal electrode pattern layer are in contact with each other.

When the internal electrode pattern layer exposed at the side surface of the green multilayer body becomes the internal electrode layer, due to the difference in a contraction behavior between the dielectric layer and the internal electrode layer during the firing, the end part of the internal electrode layer after firing tends to recedes inwards from the boundary of the element body. As a result, in the element main body, voids may be formed at the boundary between the internal electrode layer and the gap part.

The internal electrode pattern layer is also exposed at the end surface of the green multilayer body; thus, such voids may be formed to the end surfaces 2c and 2d of the element main body 2. The external electrodes are formed to the end surfaces 2c and 2d at the later stage, and upon forming the external electrode, a wet process such as a plating step may performed. At this time, when the wet process is performed while having the voids at the end surfaces 2c and 2d, the fluid such as the plating solution may infiltrate into the voids. Alternatively, when the multilayer ceramic capacitor is exposed under a high humidity atmosphere, moisture in the air may infiltrate into the voids through the external electrode.

The fluid infiltrated into the voids may eventually infiltrate to the inside of the element main body through the boundary between the internal electrode layer and the dielectric layer. Thus, an insulation property, lifetime characteristic, etc., of the multilayer ceramic capacitor may decline, and the reliability of the capacitor may also declines.

However, in the present embodiment, the boundary 5 between the multilayer body 3 and the gap part 4 on the end surface 2c of the element main body 2, that is, the boundary 5 between the internal electrode layer 32 and the gap part 4 is covered with the end surface covering parts 6a and 6b. Further, when the area of the end surface 2c is 100%, the area ratio which the end surface covering parts 6a and 6b covers the end surface 2c is 20% or greater and 50% or less. As a result, even when the fluid such as a plating solution adheres on the end surfaces 2c and 2d of the element main body 2, it is possible to effectively prevent the infiltration into the voids. Therefore, even if the external electrode is formed to the end surface of the element main body 2 through a wet process, it is possible to downsize and also achieve a higher capacity of the multilayer ceramic capacitor while achieving excellent reliability of the multilayer ceramic capacitor.

The area of the end surface covered with the end surface covering part(s) is a total area covered with the end surface covering part(s) on one end surface. That is, when the area of the end surface 2c shown in FIG. 5 is 100%, a total area of the end surface 2c covered with all of the end surface covering parts existing on said end surface (in FIG. 5, the two end surface covering parts 6a and 6b) is 20% or greater and 50% or less. Therefore, regarding the end surface 2d on the other side, similarly to the end surface 2c, a total area of the end surface 2d covered with the two end surface covering parts 6c and 6d is 20% or greater and 50% or less.

The area ratio on the end surface 2c covered with the end surface covering parts 6a and 6b and the area ratio on the end surface 2d covered with the end surface covering parts 6c and 6d may be the same or different as long as the area ratio is within the above-mentioned range. Depending on a method for forming the end surface covering part, the area ratio of one end surface covered with the end surface covering part and the area ratio of the other end covered with the end surface covering part may be different.

Also, an area on one end surface 2c that each of the two end surface covering parts 6a and 6b covers the boundary 5 may be the same or different as long as the total area is within the above-mentioned range. In the present embodiment, preferably the area of each of the two end surface covering parts 6a and 6b is the same. Here, “the same” means that the areas may be the exact same or may differ by about several %. The end surface covering part may be formed only on the end surface.

The area that the end surface covering part covering the end face may be between 25% or greater and 45% or less, or may be between 30% or greater and 40% or less.

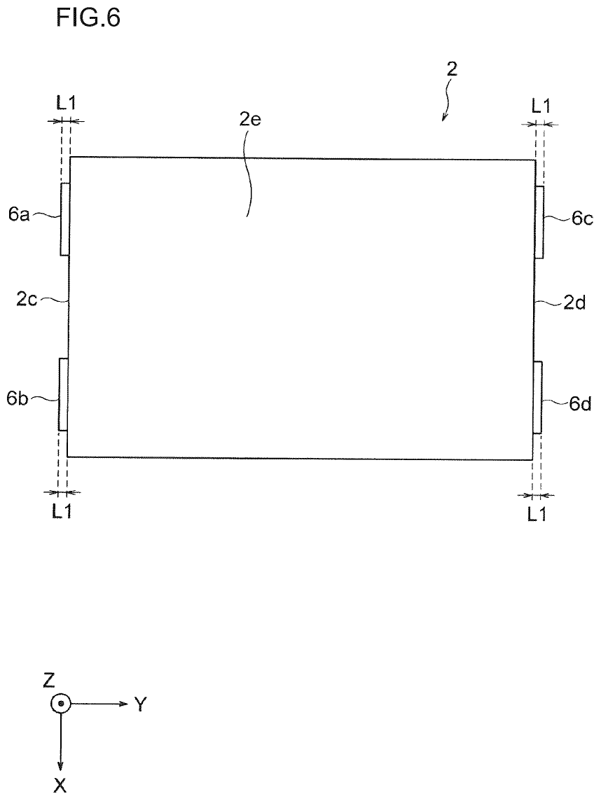

Also, as shown in FIG. 6, the length L1 (a thickness of the end surface covering part) of the end surface covering part (6a to 6d) in the Y-axis direction may preferably be between 4 μm or longer and 15 μm or shorter. By securing the thickness L1 of the end surface covering part within the above-mentioned range, it is possible to further limit the infiltration of the fluid into the voids on the end surface.

The thickness L1 of the end surface covering part may be between 6 μm or longer and 13 μm or shorter, or may be between 8 μm or longer and 10 μm or shorter.

A material of the end surface covering part may be any material as long as the infiltration of the fluid into the voids on the end surface can be limited. In the present embodiment, the material of the end surface covering part may preferably be a material having an insulation property, and more preferably the material includes a dielectric, and even more preferably the material may be a dielectric configuring the dielectric layer. Thereby, the end surface covering part is easily integrated with the end surface, and other material is not needed.

### 2. Second Embodiment

In the second embodiment, the explanations which are the common configurations with the first embodiment will be simplified or skipped. Similarly to the first embodiment, a multilayer ceramic capacitor is explained as one example of the electronic device, and FIG. 1 to FIG. 6 are referred for the explanation. That is, as shown in FIG. 4, the element main body 2 includes the multilayer body 3 and the gap part 4; and, as shown in FIG. 2, FIG. 5, and FIG. 6, at the end surfaces 2c and 2d of the element main body 2, the boundary 5 between the multilayer body 3 and the gap part 4 is covered with the end surface covering part (6a to 6d).

In the present embodiment, the end surface covering part covers the boundary 5 between the multilayer body 3 and the gap part 4 on the end surface, and also the end surface covering part at least partially covers the gap part. Further, a size of the end surface covering part on the end surface is specified. Specifically, as shown in FIG. 5, a covering length W1 of the end surface covering part in a direction towards the center of the end surface from the boundary along the X-axis direction is between 10 μm or longer and 55 μm or shorter.

As mentioned in the first embodiment, the voids are formed when the internal electrode pattern layer contracts. Thus, the voids tend to be formed toward the center of the multilayer body 3 from the boundary 5 in the X-axis direction. Thus, by setting the covering length W1 within the above-mentioned range, the voids are sufficiently covered with the end surface covering part; hence, the fluid is limited from infiltrating into the voids on the end surface, which is similar to the first embodiment. As a result, even if the external electrode is formed to the end surface of the element main body through a wet process, it is possible to downsize and also achieve higher capacity of the multilayer ceramic capacitor while achieving excellent reliability of the multilayer ceramic capacitor.

The covering length W1 of the end surface covering part is a covering length of one end surface covering part on one end surface 2c. That is, although FIG. 5 shows two end surface covering parts 6a and 6b on the end surface 2c, the covering length W1 is a length of each of the two end surface covering parts 6a and 6b. Regarding the other end surface 2d, the covering length W1 is a length of each of the two end surface covering parts, similarly to the end surface 2c.

Also, the covering length W1 of the end surface covering part may be the same or different between each end surface covering part as long as it is within the above-mentioned range. Depending on the method for forming the end surface covering part, the covering length W1 of one end surface covering part and the covering length W1 of the other end surface covering part may be different.

The covering length W1 of the end surface covering part may be between 15 μm or longer and 50 μm or shorter, may be between 20 μm or longer and 45 μm or shorter, or may be between 25 μm or longer and 40 μm or shorter.

When the covering length W1 of the end surface covering part is within the above-mentioned range, a size of the element main body is a length W in the X-axis direction of 0.3 mm or longer and 0.5 mm or shorter, a length L in the Y-axis direction of 0.5 mm or longer and 0.7 mm or shorter, and a length T in the Z-axis direction of 0.3 mm or longer and 0.5 mm or shorter.

The length L1 (a thickness of the end surface covering part) of the end surface covering part in the Y-axis direction may preferably be the same as that of the first embodiment. Also, the material of the end surface covering part can be the same as that of the first embodiment.

### (3. Method for Manufacturing Multilayer Capacitor)

Next, an example of a method for manufacturing the multilayer ceramic capacitors shown in the first embodiment and the second embodiment is described in detail.

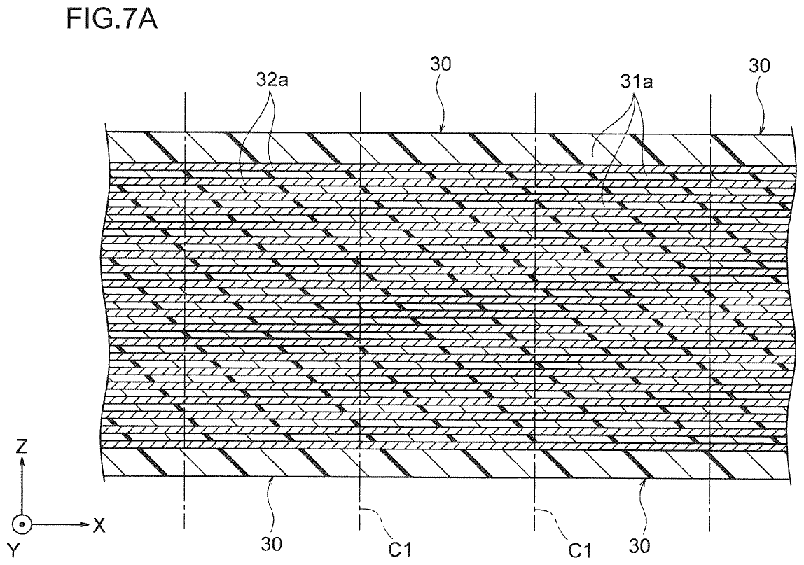

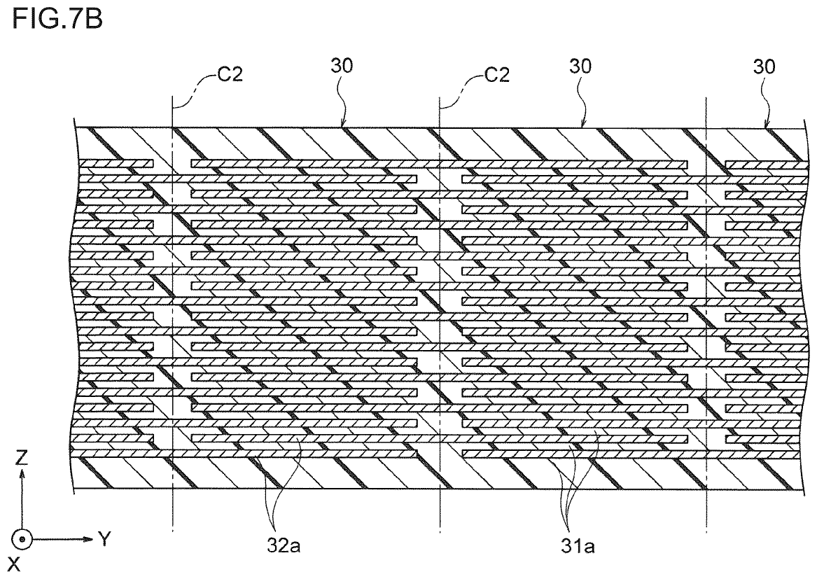

First, a green sheet 31a shown in FIG. 7A which becomes a dielectric layer 31 shown in FIG. 3 after firing is prepared.

A green sheet paste is prepared to form the green sheet 31a. The green sheet paste is normally configured of an aqueous paste or an organic solvent paste obtained by kneading a ceramic powder having a dielectric property and an organic vehicle together.

The raw material of the ceramic powder may be appropriately selected from various compounds that become oxides or complex oxides; and, examples of such compounds include carbonate, nitrate, hydroxide, and organic metal compounds. The selected compounds may be mixed together to be used. In the present embodiment, the raw material of the ceramic powder is a powder having an average particle size of 0.45 μm or smaller, or preferably between 0.05 and 0.3 μm or so. Note that, in order to achieve extremely thin green sheet, it is desirable to use a powder finer than a thickness of the green sheet.

Next, an internal electrode pattern layer 32a shown in FIG. 7A is formed which becomes an internal electrode layer 32 shown in FIG. 2 after firing. An internal electrode layer paste is prepared to form the internal electrode pattern layer. The internal electrode layer paste is prepared by kneading a conductor including the above-mentioned various conductive metals and alloys together with the above-mentioned organic vehicle. A metal paste (an external electrode paste) which becomes an underlayer of the external electrodes 8a and 8b shown in FIG. 1 after firing may be prepared in the similar manner as in the case of the above-mentioned internal electrode layer paste.

Using the green sheet paste and the internal electrode layer paste prepared as mentioned in above, the green sheets 31a and the internal electrode pattern layers 32a are stacked in an alternating manner as shown in FIG. 7A and FIG. 7B. Further, a plurality of green sheets is formed to the both sides in the stacking direction, and pressure is applied in the stacking direction to give a green sheet multilayer body.

As the method for manufacturing the green sheet multilayer body, other than mentioned in above, the plurality of green sheets may be formed, and a predetermined number of the internal green sheets 31a and a predetermined number of the internal electrode pattern layers 32a may be stacked in an alternating manner on the plurality of green sheets. Then, pressure may be applied in the stacking direction to give the green sheet multilayer body.

Next, the green sheet multilayer body is cut along a cutting plane C1 and a cutting plane C2 shown in FIG. 7A and FIG. 7B to give a green multilayer body 30. The cutting plane C1 is a plane parallel to a Y-Z plane, and the cutting plane C2 is a plane parallel to a Z-X plane.

As shown in FIG. 7B, the two cutting planes C2, which are adjacent to a cutting plane C2 cutting one internal electrode pattern layer 32a at a n^{th} layer, cut the space between the internal electrode pattern layers 32a. Also, the cutting plane C2 cutting the internal electrode pattern layer 32a at the n^{th} layer cuts the space between the internal electrode pattern layers 32a at a n+1^{th} layer.

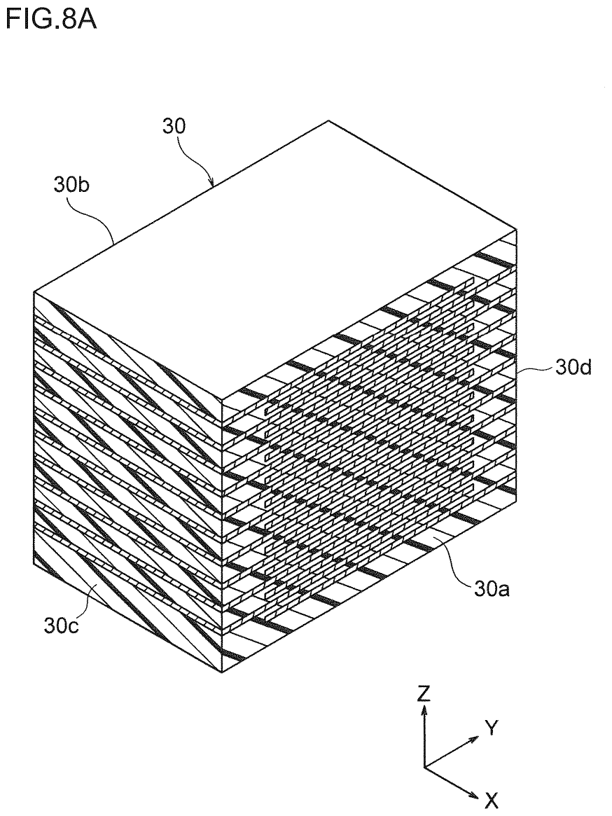

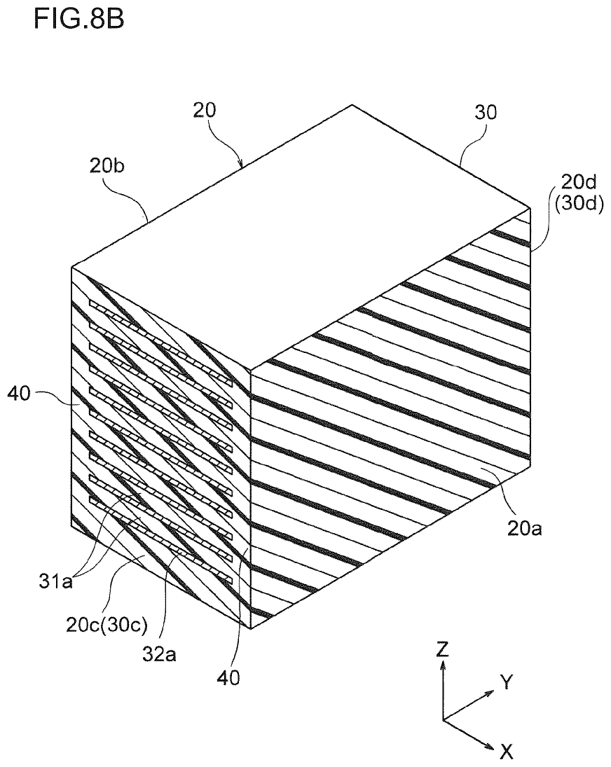

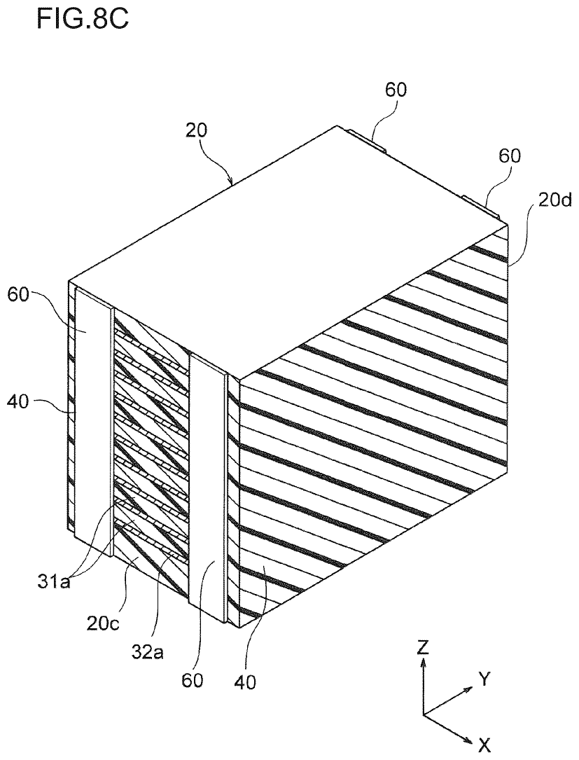

By obtaining the green multilayer body 30 shown in FIG. 8A using such cutting method, the internal electrode pattern layer 32a at the n^{th} layer of the green multilayer body 30 exposes at one end surface 30d in the Y-axis direction of the green multilayer body 30 and does not expose at the other end surface 30c. On the other hand, the internal electrode pattern layer 32a at the n+1^{th} layer of the green multilayer body 30 does not expose at one end surface 30d in the Y-axis direction of the green multilayer body 30 and exposes at the other end surface 30c.

Further, all of the internal electrode pattern layers 32a expose at the cutting plane C1 of the green multilayer body 30 shown in FIG. 8A; that is, the internal electrode pattern layers 32a are exposed at the side surfaces 30a and 30b which are facing each other in the X-axis direction of the green multilayer body 30 shown in FIG. 8A. Note that, a method for forming the internal electrode pattern layer 32a is not particularly limited, and other than a printing method and a transferring method, a thin layer forming method such as deposition and spattering may be used.

Next, a green gap part 40 is formed which becomes the gap part 4 shown in FIG. 2 after firing to the side surfaces 30a and 30b facing each other in the X-axis direction of the obtained green multilayer body 30. Thereby, a green chip 20 shown in FIG. 8B is obtained. Examples of a method for forming the green gap part include, a coating method which applies the paste on the side surfaces, a dipping method which immerse the side surfaces into the paste, a pasting method pasting a sheet which becomes the green gap part to the side surfaces, a method which sprays to the side surfaces, and a spin coat method.

In the present embodiment, preferably the pasting method may be used to form the green gap part to the side surfaces of the green multilayer body. For example, an adhesive layer may be formed to the sheet which becomes the side surface and/or the green gap part, and thereby, the sheet can be pasted on the side surface.

The sheet which becomes the green gap part is a sheet including a material having an insulation property. Examples of such material include glass, ceramics, etc. In the present embodiment, ceramics are preferable, dielectrics are more preferable, and the dielectrics included in the above-mentioned green sheet paste are even more preferable.

Next, as shown in FIG. 8C, a green covering part 60 which becomes the end surface covering part 6 shown in FIG. 2 after firing is formed to the end surfaces 20c and 20d facing each other in the Y-axis direction of the obtained green chip 20. Examples of a method for forming the green covering part include a method which was described as the method for forming the green gap part. In the present embodiment, preferably the green covering part is formed using a pasting method pasting the sheet which becomes the green covering part to the end surface, or a dipping method which immerses the end surface into the paste.

In the case of using the pasting method, the sheet which becomes the green gap part is a sheet including a material having an insulation property, similarly to the sheet which becomes the green gap part. Examples of such material having an insulation property include glass, ceramics, etc. In the present embodiment, ceramics are preferable, dielectrics are more preferable, and the dielectrics included in the above-mentioned green sheet paste are even more preferable.

For the dipping method, preferably, a paste including a material having an insulation property is used. Examples of such material having an insulation property include glass, ceramics, etc. In the present embodiment, ceramics are preferable, dielectrics are more preferable, and a paste including the dielectrics included in the above-mentioned green sheet paste are even more preferable.

The green chip 20 to which the green covering part is formed is subject to solid drying to remove a plasticizer, and then, the green chip 20 is solidified. The dried green chip 20 is then subject to a binder removal step, a firing step, and if needed an annealing step, to give an element main body 2 shown in FIG. 2.

In the present embodiment, for example, the binder removal step may be carried out at a holding temperature between 200° C. and 400° C. The firing step may be carried out under reducing atmosphere, and the annealing step may be carried out under neutral or weakly acidic atmosphere. For other conditions concerning the firing step and the annealing step, for example, the holding temperature for firing may be between 1000° C. and 1300° C., and the holding temperature for annealing may be between 500° C. and 1100° C. The binder removal step, the firing step, and the annealing step may be performed continuously or independently.

Next, the pair of external electrodes is formed to the pair of end surfaces facing each other in the Y-axis direction of the obtained element main body. As a method for forming the external electrode, any known method can be used. In the present embodiment, preferably the underlayer may be formed by applying and firing the external electrode on the end surface of the element main body, and then, the plating layer may be formed on the underlayer. At this time, at least part of the end surface of the element main body and at least part of the end surface covering part are covered with the external electrode. Even if voids are formed in the internal electrode layer on the end surface, said voids are covered with the end surface covering part; thus, when the external electrode is being formed, it is possible to limit the fluid such as plating solution or so from infiltrating into the voids.

A firing temperature of the external electrode paste applied on the end surface is preferably 400° C. or higher and 800° C. or lower. Thereby, it is possible to achieve good electrical connection between the internal electrode layer and the external electrode.

As a method for forming the plating layer, any known plating method can be used.

The multilayer ceramic capacitor 1 shown in FIG. 1 is manufactured by going through the above-mentioned steps. The multilayer ceramic capacitor is mounted on a printed circuit board and the like using soldering or so, and then used in various electronic devices.

### 4. Modified Example

Also, in the above-mentioned embodiment, a multilayer ceramic capacitor is described as one example of an electronic device according to the present disclosure. However, the electronic device according to the present disclosure may be any electronic device other than the multilayer ceramic capacitor. As such electronic device, as long as the electronic device has a configuration that the dielectric layers and the internal electrode layers are stacked, it may be any electronic device. Examples include band-pass filters, inductors, multilayer 3-terminal filters, piezoelectric elements, PTC thermistors, NTC thermistors, varistors, etc.

Hereinabove, the embodiments of the present disclosure are described; however, the present disclosure is not limited to the above-mentioned embodiments, and various modifications are possible within the scope which does not exceed the gist of the present disclosure.

### EXAMPLES

Below describes the present disclosure based on further detailed examples; however, the present disclosure is not limited to these examples.

### Example 1

BaTiO₃-based dielectric raw material: 100 parts by mass, polyvinyl butyral resin: 10 parts by mass, dioctyl phthalate (DOP) as a plasticizer: 5 parts by mass, and alcohol as a solvent: 100 parts by mass were mixed in a ball mill to form a paste, and to give a green sheet paste.

Then, separately from the above, Ni powder: 44.6 parts by mass, terpineol: 52 parts by mass, ethyl cellulose: 3 parts by mass, and benzotriazole: 0.4 parts by mass were kneaded using a triple roller mill to form a slurry and to produce an internal electrode layer paste.

The green sheet paste produced in above was used to form a green sheet 31a on a PET film. Next, using the internal electrode layer paste, the internal electrode pattern layer 32a was formed on the green sheet 31a to give the green sheet 31a having the internal electrode pattern layer 32a.

The obtained green sheets 31a having the internal electrode pattern layers 32a were stacked to manufacture an internal multilayer body. Then, the green sheet pastes were provided on the top and the bottom of the internal multilayer body to form a predetermined layers of green sheets 31a, and pressure was applied in a stacking direction to give a green sheet multilayer body.

Next, as shown in FIG. 7A, FIG. 7B, and FIG. 8A, the green sheet multilayer body was cut along a cutting plane C1 and a cutting plane C2 to give a green multilayer body.

As shown in FIG. 8B, at both surfaces (side surfaces) in the X-axis direction of the obtained green multilayer body, the green sheet 31a, which the size was adjusted and also an adhesive was applied, was pasted to form the green gap part 40. Thereby, the green chip 20 was obtained. The green gap part becomes a gap part after firing.

Next, as shown in FIG. 8C, the green sheet 31a as an end surface sheet which the size was adjusted and the adhesive was applied was pasted on both surfaces (end surfaces 20c and 20d) in the Y-axis direction of the obtained green multilayer body 30 (the green chip 20) having the green gap part 40. The green sheet 31a was pasted on the green multilayer body 30 so that the boundary between the green multilayer body and the green gap part was covered. Thereby, a green covering part 60 was formed. The green covering part was formed on two places of one end surface. The green covering part becomes the end surface covering part after firing.

A total area that the two green covering parts cover the end surface was adjusted to be 20% after firing with respect to 100% of an area of one end surface. Also, a covering length of the green covering part in a direction towards the center of the end surface from the boundary along the X-axis was adjusted so that the covering length W1 of the end surface covering part after firing was 10 μm. Further, a length L1 (thickness) of the green covering part in the Y-axis was adjusted so that the thickness of the end surface covering part after firing was 4 μm.

Next, a binder removal treatment, firing, and annealing were performed to the green chip having the green covering part under the following conditions; thereby, the element main body having the end surface covering part was obtained.

As for the conditions of the binder removal treatment, the temperature increasing rate was 300° C./hour, the holding temperature was 400° C., the temperature holding time was 5 hours, and the atmosphere was in the air.

As for the firing conditions, the temperature increasing rate was 10 k° C./hour, the holding temperature was 1200° C., and the holding time was 2 minutes. The temperature decreasing rate was 300° C./hour. The atmosphere gas was a humidified N₂+H₂ mixed gas, and the oxygen partial pressure was adjusted to 10 to 12 MPa.

As for the annealing conditions, the temperature increasing rate was 300° C./hour, the holding temperature was 900° C., the temperature holding time was 3 hours, the temperature decreasing rate was 300° C./hour, and the atmosphere gas was a humidified N₂ gas (the oxygen partial pressure: 10-7 MPa).

A wetter was used for humidifying of the atmosphere gas for firing and annealing.

Next, a Cu powder, a glass frit, and an organic vehicle were kneaded to give an external electrode paste. The prepared external electrode paste was applied on the element main body so that the end surface of the element main body and the end surface covering part were covered with the external electrode paste. Then, firing was performed at 700° C. to form the underlayer of the external electrode. Then, using barrel plating, a Ni plating layer and a Sn plating layer were formed in this order on the underlayer to form the external electrode. Thereby, a sample of the multilayer ceramic capacitor as an electronic device was obtained.

### Examples 2 to 4 and Comparative Examples 2 and 4

Multilayer ceramic capacitors were obtained using the same method as in the case of Example 1, except that the total area ratio, the covering length, and the thickness of the end surface covering part were adjusted to the values shown in Table 1.

### Examples 5 to 8 and Comparative Examples 3 and 5

Multilayer ceramic capacitors were obtained using the same method as in the case of Example 1, except that instead of pasting the end surface sheet, the dielectric paste was dip coated to the end surface to form the green covering part, and the total area ratio, the covering length, and the thickness of the end surface covering part were adjusted to the values shown in Table 1.

### Comparative Example 1

A multilayer ceramic capacitor was obtained using the same method as in the case of Example 1, except that the end surface covering part was not formed.

The multilayer ceramic capacitor samples obtained in the above-mentioned examples and comparative examples were subject to the below evaluations.

### (Humidity Load Life Test)

In Examples 1 to 8 and Comparative examples 1 to 5, 100 of each sample were subject to an accelerated humidity load life test which applied voltage at a temperature of 120° C. and under atmosphere of 98% humidity. After the test, the number of samples which the insulation resistance dropped by one digit or more compared to the initial value was counted. The results are shown in Table 1.

### (Contact Rate)

For each sample of Examples 1 to 8 and Comparative examples 1 to 5, a contact rate was evaluated. For the contact rate, a ratio of the number of samples which reached the desired capacitance was calculated, and the results were shown in %. The results are shown in Table 1.

### (Base Board Mounting Evaluation)

For each sample of Examples 1 to 8 and Comparative examples 1 to 5, the condition of the multilayer ceramic capacitor upon mounting on the base board was evaluated as described in below. Specifically, when a solder shape (fillet) after mounting on the base board had a smooth concave curve of flared shape, then it was evaluated good. The results are shown in Table 2. Note that, in Comparative examples 3 and 5, the thickness L1 of the covering part was significantly over the terminal part; thus, due to this, Comparative examples 3 and 5 exhibited a poor solder wettability. Hence, it was evaluated NG. Also, in Comparative examples 1, 2, and 4, numerous samples exhibited poor humidity load life test results prior to mounting on the base board. Thus, for these comparative examples, it was not possible to proceed with the further evaluations, hence, these comparative examples were not subject to the base board mounting evaluation.

TABLE 1

| | | | Area ratio | | | | | Numbers of | Capacitance |
|---|---|---|---|---|---|---|---|---|---|
| | End | | of end | Length W1 | | Thickness L1 | | failure of | acquired |
| | surface | | surface | of covering | | of covering | | humidity load | amount |
| | covering | Green covering | covering | part | | part | | life test after | (Contact |
| | part | part | part | μm | | μm | | plating treatment | rate) |
| Example 1 | Formed | End surface sheet | 20% | 10 | μm | 4 | μm | 0/100 | 100% |
| Example 2 | Formed | End surface sheet | 20% | 10 | μm | 15 | μm | 0/100 | 100% |
| Example 3 | Formed | End surface sheet | 50% | 55 | μm | 4 | μm | 0/100 | 100% |
| Example 4 | Formed | End surface sheet | 50% | 55 | μm | 15 | μm | 0/100 | 100% |
| Example 5 | Formed | End surface paste | 20% | 10 | μm | 4 | μm | 0/100 | 100% |
| Example 6 | Formed | End surface paste | 20% | 10 | μm | 15 | μm | 0/100 | 100% |
| Example 7 | Formed | End surface paste | 50% | 55 | μm | 4 | μm | 0/100 | 100% |
| Example 8 | Formed | End surface paste | 50% | 55 | μm | 15 | μm | 0/100 | 100% |
| Comparative | Not | Not formed | 0% | Not formed | | — | | 40/100 | 100% |
| example 1 | formed | | | | | | | | |
| Comparative | Formed | End surface sheet | 17% | 5 | μm | 2 | μm | 35/100 | 100% |
| example 2 | | | | | | | | | |
| Comparative | Formed | End surface paste | 17% | 5 | μm | 20 | μm | 15/100 | 100% |
| example 3 | | | | | | | | | |
| Comparative | Formed | End surface sheet | 70% | 85 | μm | 2 | μm | 35/100 | 10% |
| example 4 | | | | | | | | | |
| Comparative | Formed | End surface paste | 70% | 85 | μm | 20 | μm | 0/100 | 10% |

example 5

TABLE 2

| | Evaluation | |
|---|---|---|
| | upon mounting | Reason for unfavorable |
| | on base board | evaluation result |
| Example 1 | Good | — |
| Example 2 | Good | — |
| Example 3 | Good | — |
| Example 4 | Good | — |
| Example 5 | Good | — |
| Example 6 | Good | — |
| Example 7 | Good | — |
| Example 8 | Good | — |
| Comparative | N/A | Number of samples |
| example 1 | | exhibiting poor results of |
| | | humidity load life test |
| | | prior to mounting of base |
| | | board |
| Comparative | N/A | Number of samples |
| example 2 | | exhibiting poor results of |
| | | humidity load life test |
| | | prior to mounting of base |
| | | board |
| Comparative | Poor solder | Thickness of the covering |
| example 3 | wettability | part was over terminal |
| | | part |
| Comparative | N/A | Number of samples |
| example 4 | | exhibiting poor results of |
| | | humidity load life test |
| | | prior to mounting of base |
| | | board |
| Comparative | Poor solder | Thickness of the covering |
| example 5 | wettability | part was over terminal |
| | | part |

According to Tables 1 and 2, when the end surface covering part satisfied the above-mentioned area ratio and the covering length, the results of humidity load life test were good, the contact rates were high, and also the mounting state to the base board were good.

### REFERENCE SIGNS LIST

1 . . . . Multilayer ceramic capacitor
2 . . . . Element main body
20 . . . . Green chip
3 . . . . Multilayer body
30 . . . . Green multilayer body
31 . . . . Dielectric Layer
31a . . . . Green sheet
32 . . . . Internal electrode layer
32a . . . . Internal electrode pattern layer
4 . . . . Gap part
40 . . . . Green gap part
6 . . . . End surface covering part
60 . . . . Green covering part
8 . . . . External electrode

What is claimed is:

1. An electronic device, comprising:
an element main body including;
a multilayer body having an internal electrode layer and a dielectric layer, both being substantially parallel to a plane including a first axis and a second axis perpendicular to the first axis, and stacked along a direction of a third axis perpendicular to the plane including the first axis and the second axis, and
a gap part formed toa side surface disposed at an end in a direction of the first axis of the multilayer body; and
an external electrode electrically connected to the internal electrode layer;
wherein a boundary part between the multilayer body and the gap part exposed on an end surface being disposed at an end in a direction of the second axis of the element main body is at least partially covered by an end surface covering part,
an area ratio of the end surface covering part is between 20% or greater and 50% or less with respect to 100% of an area of the end surface, and
the external electrode covers at least part of the end surface and at least part of the end surface covering part.

2. An electronic device, comprising:
an element main body including;
a multilayer body having an internal electrode layer and a dielectric layer, both being substantially parallel to a plane including a first axis and a second axis perpendicular to the first axis, and stacked along a direction of a third axis perpendicular to the plane including the first axis and the second axis, and
a gap part formed to a side surface disposed at an end in a direction of the first axis of the multilayer body; and
an external electrode electrically connected to the internal electrode layer;
wherein a boundary part between the multilayer body and the gap part exposed on an end surface being disposed at an end in a direction of the second axis of the element main body is at least partially covered by an end surface covering part,
the end surface covering part at least partially covers the gap part and has a covering length of 10 μm or greater and 55 μm or less from the boundary towards a center in the direction of the first axis of the end surface, and
the external electrode covers at least part of the end surface covering part and at least part of the end surface.

3. The electronic device according to claim 1, wherein the end surface covering part comprises a plurality of end surface covering parts formed on the end surface.

4. The electronic device according to claim 2, wherein the end surface covering part comprises a plurality of end surface covering parts formed on the end surface.

5. The electronic device according to claim 1, wherein a length of the end surface covering part in a direction along the second axis is between 4 μm or greater and 15 μm or less.

6. The electronic device according to claim 2, wherein a length of the end surface covering part in a direction along the second axis is between 4 μm or greater and 15 μm or less.

7. The electronic device according to claim 1, wherein the end surface covering part comprises a dielectric.

8. The electronic device according to claim 2, wherein the end surface covering part comprises a dielectric.

9. The electronic device according to claim 1, wherein the external electrode comprises an underlayer and a plating layer formed on the underlayer.

10. The electronic device according to claim 2, wherein the external electrode comprises an underlayer and a plating layer formed on the underlayer.

11. A method for manufacturing the electronic device according to claim 1, comprising:
forming of a green multilayer body by stacking an internal electrode pattern layer and a green sheet, both substantially parallel to a plane including a first axis and a second axis, along a direction of a third axis,
the internal electrode pattern layer being exposed from a side surface disposed at an end in a direction of a first axis of the green multilayer body and also being exposed from an end surface disposed at an end in a direction of a second axis of the green multilayer body;
obtaining a green chip by forming a green gap part to the side surface;
forming a green covering part covering a boundary between the green multilayer body and the green gap part to the end surface disposed at the end in the direction of the second axis of the green chip;
obtaining an element main body having the end surface covering part by firing the green chip provided with the green covering part; and
forming an external electrode on the end surface disposed at the end in the direction of the second axis of the element main body to cover at least part of the end surface covering part and at least part of the end surface.

12. A method for manufacturing the electronic device according to claim 2, comprising:
forming of a green multilayer body by stacking an internal electrode pattern layer and a green sheet, both substantially parallel to a plane including a first axis and a second axis, along a direction of a third axis
the internal electrode pattern layer being exposed from a side surface disposed at an end in a direction of a first axis of the green multilayer body and also being exposed from an end surface disposed at an end in a direction of a second axis of the green multilayer body;
obtaining a green chip by forming a green gap part to the side surface;
forming a green covering part covering a boundary between the green multilayer body and the green gap part to the end surface disposed at the end the direction of the second axis of the green chip;
obtaining an element main body having an end surface covering part by firing the green chip provided with the green covering part; and
forming an external electrode on an end surface disposed at an end in the direction of the second axis of the element main body to cover at least part of the end surface covering part and at least part of the end surface.

13. The method for manufacturing the electronic device according to claim 11, wherein forming of the green covering part includes applying an end surface sheet to the end surface of the green chip.

14. The method for manufacturing the electronic device according to claim 12, wherein forming of the green covering part includes applying an end surface sheet to the end surface of the green chip.

15. The method for manufacturing the electronic device according to claim 11, wherein forming the green covering part includes immersing the end surface of the green chip in an end surface paste.

16. The method for manufacturing the electronic device according to claim 12, wherein forming the green covering part includes immersing the end surface of the green chip in an end surface paste.
